(19) United States
(12) Patent Application Publication
(10) Pub. No.: US 2011/0107425 A1
(43) Pub. Date: May 5, 2011

(54) APPARATUS AND METHOD FOR PERFORMING VIRUS SCAN IN PORTABLE TERMINAL

(75) Inventors: Woo-Kwang LEE, Suwon-si (KR); Sang-Ho PARK, Anyang-si (KR)

(73) Assignee: SAMSUNG ELECTRONICS CO. LTD., Suwon-si (KR)

(21) Appl. No.: 12/907,414

(22) Filed: Oct. 19, 2010

(30) Foreign Application Priority Data
Nov. 4, 2009 (KR) 10-2009-0106218

(51) Int. Cl. G06F 12/14; G06F 12/16; G06F 11/08

(52) U.S. Cl. 726/24; 711/162; 714/6.12; 711/E12.103; 714/E11.03

(57) ABSTRACT

An apparatus and method are provided in which, in order to avoid a situation where a vaccine installed in a portable terminal is damaged by a virus and thus a virus scan process cannot be normally performed, when the portable terminal operates as a removable disk or when an external memory is placed in the portable terminal, whether the vaccine installed in the portable terminal is damaged is determined to recover the damaged vaccine, and a version of the vaccine installed in the portable terminal is determined to update the vaccine to the latest version. The apparatus includes a memory divided into a storage area and a backup area to install a vaccine in the storage area and to back up the vaccine in the backup area.

### PRIORITY

This application claims the benefit under 35 U.S.C. §119(a) of a Korean patent application filed in the Korean Intellectual Property Office on Nov. 4, 2009 and assigned Serial No. 10-2009-0106218, the entire disclosure of which is hereby incorporated by reference.

### BACKGROUND OF THE INVENTION

1. Field of the Invention

The present invention relates to an apparatus and method for performing a virus scan of a portable terminal. More particularly, the present invention relates to a method and apparatus for recovering a damaged vaccine according to a damage status, when the portable terminal operates as a removable disk or when an external memory is inserted into the portable terminal.

2. Description of the Related Art

Recently, with the rapid development of portable terminals, portable terminals providing wireless voice calls and data exchanges are becoming personal necessities. Conventional portable terminals have generally been regarded as portable devices providing wireless calls. However, along with technical advances and introduction of the wireless Internet, portable terminals are now used for many purposes in addition to simple telephone calls or scheduling. For example, a portable terminal provides a variety of functions to satisfy users' demands, such as games, remote control using near field communication, capturing images using a built-in digital camera, and the like.

In addition, the portable terminal employs an embedded NAND flash memory such as MoviNAND and NAND and thus provides a function of using the memory as a removable disk to facilitate data transfer with respect to a Personal Computer (PC). The removable disk function allows the portable terminal to perform the same function as an external hard disk so that data can be transferred in an area connected to the PC.

However, the use of the removable disk function results in a problem in that a virus may spread through a memory of the portable terminal. To solve this problem, the portable terminal provides a vaccine. Since the vaccine is installed in the memory of the portable terminal, when the virus is spread to the portable terminal, the vaccine may also be damaged by the virus. When the vaccine is damaged by the virus as described above, the vaccine of the portable terminal cannot normally perform a virus scan, and thus data may be damaged by the virus. Accordingly, there is a need for an apparatus and method for recovering a vaccine damaged by a virus in a portable terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for avoiding data damaged by a virus in a portable terminal.

Another aspect of the present invention is to provide an apparatus and method for determining whether a vaccine is damaged, before a virus scan is performed in a portable terminal.

Another aspect of the present invention is to provide an apparatus and method for determining a version of a previously installed vaccine to update the vaccine to the latest version in a portable terminal.

In accordance with an aspect of the present invention, an apparatus for performing a virus scan in a portable terminal is provided. The apparatus includes a memory divided into a storage area and a backup area to install a vaccine in the storage area and to back up the vaccine of the storage area in the backup area.

In accordance with another aspect of the present invention, a method of performing a virus scan in a portable terminal is provided. The method includes dividing a memory into a storage area and a backup area, installing a vaccine in the storage area, and installing a backup of the vaccine in the backup area.

In accordance with another aspect of the present invention, a portable terminal for performing a virus scan is provided. The portable terminal includes a memory divided into a storage area and a backup area to install a vaccine in the storage area and to back up the vaccine in the backup area, and a vaccine manager for recovering the vaccine in the storage area to an uninfected vaccine when the vaccine is infected.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a structure of a portable terminal operating as a removable disk according to an exemplary embodiment of the present invention;

FIG. 2 is a flowchart illustrating a process of operating a portable terminal as a removable disk according to an exemplary embodiment of the present invention; and

FIG. 3 is a flowchart illustrating a process of updating a virus vaccine in a portable terminal according to another exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relates to an apparatus and method for determining whether a vaccine is damaged before a virus scan is performed to avoid data damaged by a virus in a portable terminal, and if the vaccine is damaged, for performing a virus scan by recovering the damaged vaccine to a normal vaccine. As used herein, a vaccine may refer to an anti-virus program to remove one or more viruses (e.g., malicious software or code) from files or storage units of the portable terminal.

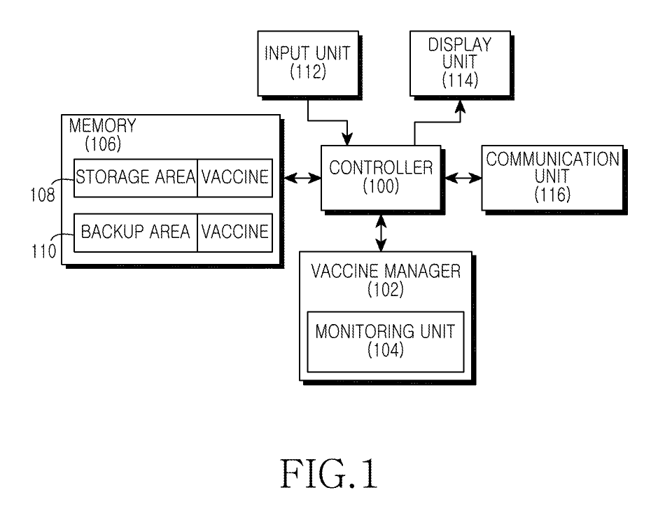

FIG. 1 is a block diagram illustrating a structure of a portable terminal operating as a removable disk according to an exemplary embodiment of the present invention.

Referring to FIG. 1, the portable terminal includes a controller 100, a vaccine manager 102, a memory 106, an input unit 112, a display unit 114, and a communication unit 116. The portable terminal may include additional units that are not illustrated here merely for sake of clarity. Similarly, the functionality of two or more of the above units may be integrated into a single component without departing from the spirit or scope of the present invention.

The controller 100 provides overall control to the portable terminal. For example, the controller 100 processes and controls voice telephony and data communication. In addition to these typical functions, according to an exemplary embodiment of the present invention, when the portable terminal operates as the removable disk or when an external memory is placed in the portable terminal, the controller 100 provides control to determine whether a virus is detected by using a vaccine installed in the memory.

In order to avoid a situation where the vaccine installed in the memory 106 is damaged by the virus and preventing performance of a virus scan process, the controller 100 determines whether the vaccine installed in the memory is damaged when the portable terminal operates as the removable disk or when the external memory is placed in the portable terminal. In this case, if it is determined that the vaccine is damaged, the controller 100 recovers the damaged vaccine to a normal vaccine by using an undamaged vaccine image (i.e., a backup vaccine image) stored in the memory 106.

The controller 100 controls the vaccine manager 102 to restore data damaged by the virus or to block the virus that damages the data. The vaccine manager 102 includes a monitoring unit 104 for determining whether the vaccine used to perform the virus scan is damaged. Under the control of the controller 100, the vaccine manager 102 determines whether the vaccine is damaged by the virus when the portable terminal operates as the removable disk or when the external memory is placed in the portable terminal If it is determined by the monitoring unit 104 that the vaccine is damaged, the vaccine manager 102 uses the vaccine image existing in the memory 106 to recover the damaged vaccine to the normal vaccine, so that a virus scan can be performed normally.

The vaccine manager 102 also determines a version of the vaccine stored in the memory 106 and updates the vaccine to the latest version. For example, when the portable terminal is initially booted or when the portable terminal operates, the vaccine manager 102 updates a vaccine having an old version to the latest version so as to promptly scan for new viruses.

The monitoring unit 104 of the vaccine manager 102 determines whether the vaccine installed in the memory 106 of the portable terminal is damaged by the virus under the control of the vaccine manager 102, and performs a virus scan process for determining whether the virus exists in the memory 106.

The memory 106 includes, for example, a Read Only Memory (ROM), a Random Access Memory (RAM), a flash ROM, and the like. The ROM stores a microcode (i.e., code) of a program, by which the controller 100 and the vaccine manager 102 are processed and controlled, and a variety of reference data. The RAM is a working memory of the controller 100 and stores temporary data that is generated while programs are performed. The flash ROM stores a variety of rewritable data, such as phonebook entries, outgoing messages, and incoming messages.

The memory 106 can be divided into a storage area 108 accessible by a user and a backup area 110 not accessible by the user. A vaccine for scanning and curing the virus of the memory 106 exists in the storage area 108 of the memory 106. When the vaccine existing in the storage area 108 is infected by the virus, a vaccine image capable of recovering the infected vaccine exists in the backup area 110. For example, the storage area 108 accessible by the user may be a storage area in which a right to read and write data stored in the storage area 108 is given to the user of the portable terminal, and the backup area 110 not accessible by the user may be a storage area in which only a right to read data stored in the storage area is given to the user of the portable terminal.

The input unit 112 includes a plurality of function keys, such as numeral key buttons of ‘0’ to ‘9’, a menu button, a cancel button, an OK button, a talk button, an end button, an Internet access button, a navigation key button, a character input key, and the like. Key input data (e.g., power on), which is input when the user presses these keys, is provided to the controller 100.

The display unit 114 displays information such as state information, which is generated while the portable terminal operates, limited numeric characters, large volumes of moving and still pictures, and the like. The display unit 114 may be a color Liquid Crystal Display (LCD), an Active Mode Organic Light Emitting Diode (AMOLED), and the like. The display unit 114 may have a touch input device. When the display unit 114 having the touch input device is applied to a touch input type mobile terminal, the display unit 114 may serve as an input unit.

The communication unit 116 transmits and receives a Radio Frequency (RF) signal of data that is input and output through an antenna (not illustrated). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data. According to an exemplary embodiment of the present invention, a message for requesting the latest version is transmitted to a vaccine server for providing a vaccine of the latest version, and the vaccine of the latest version is received in response to the request.

The functions of the vaccine manager 102 may be performed by the controller 100 of the portable terminal. These elements are shown separately in FIG. 1 for exemplary purposes only. Thus, those of ordinary skill in the art can understand that various modifications can be made within the scope of the present invention. For example, these elements may be constructed such that their functions are both processed by the controller 100.

An apparatus for determining whether a vaccine is damaged before a virus scan is performed to avoid data damaged by a virus in a portable terminal, and if the vaccine is damaged, for performing a virus scan by recovering the damaged vaccine to a normal vaccine has been described above. Hereinafter, a method of recovering the vaccine damaged by the virus and for improving virus scan capability by updating a previously installed vaccine to a vaccine of the latest version will be described.

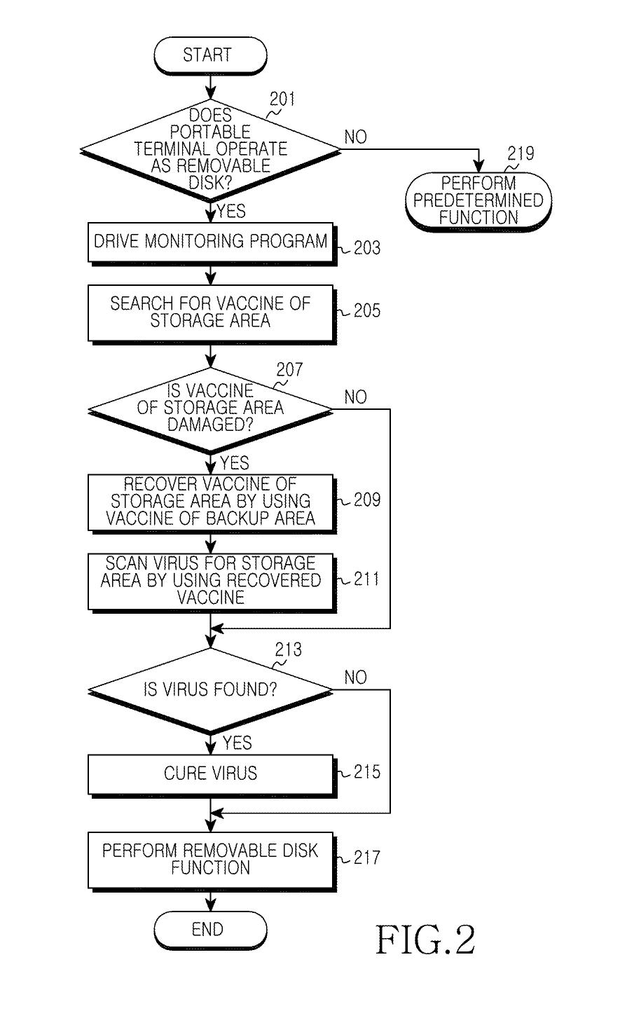

FIG. 2 is a flowchart illustrating a process of operating a portable terminal as a removable disk according to an exemplary embodiment of the present invention.

Referring to FIG. 2, the portable terminal determines in step 201 whether the portable terminal operates as the removable disk such as an external hard disk. If it is determined in step 201 that the portable terminal does not operate as the removable disk, the portable terminal performs a predetermined function in step 219 (e.g., a standby mode).

Otherwise, if it is determined in step 201 that the portable terminal operates as the removable disk, the portable terminal drives a program for monitoring a memory of the portable terminal in step 203, and monitors a vaccine of a storage area in step 205. The monitoring program is a program for monitoring whether a virus vaccine in the storage area is damaged in a disk area divided into the storage area accessible by a user and a backup area not accessible by the user.

In step 207, the portable terminal determines whether the vaccine of the storage area is damaged. Damage to the vaccine of the storage area may indicate that the vaccine stored in the storage area accessible by the user is mistakenly deleted by the user or that a vaccine program for a virus scan of the memory used as the removable disk is damaged by a virus.

If it is determined in step 207 that the vaccine of the storage area is damaged, the portable terminal recovers the vaccine of the storage area using the vaccine of the backup area in step 209, and performs a virus scan for the storage area using the vaccine in step 211. The portable terminal can recover the damaged vaccine by copying an undamaged vaccine stored in the backup area to the storage area or by curing the damaged vaccine of the storage area by using the vaccine stored in the backup area.

If it is determined in step 207 that the vaccine of the storage area is not damaged, the portable terminal determines that the vaccine of the storage area is safe and thus performs a virus scan for the storage area by using the vaccine of the storage area. In step 213, the portable terminal determines a result of the virus scan.

If the virus is not found in the storage memory according to the result of the virus scan in step 213, the portable terminal performs the removable disk function in step 217. If a virus is found in the storage memory according to the result of the virus scan in step 213, the portable terminal cures the virus in step 215 before performing the removable disk function in step 217.

Although whether the vaccine of the memory is damaged is determined in FIG. 2 when the portable terminal operates as the removable disk, the portable terminal can also determine whether the vaccine of the memory is damaged when the external memory is placed in the portable terminal.

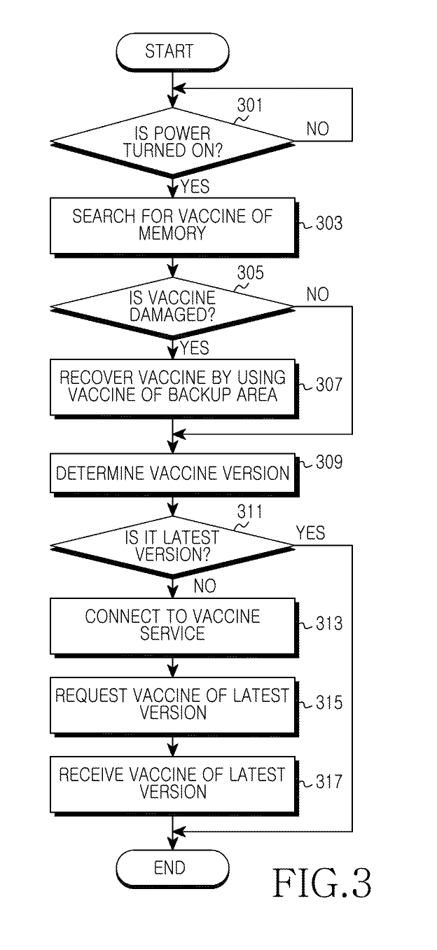

FIG. 3 is a flowchart illustrating a process of updating a virus vaccine in a portable terminal according to another exemplary embodiment of the present invention.

Referring to FIG. 3, the portable terminal determines whether power is tuned on by a user in step 301. If it is determined in step 301 that the power is turned on, the portable terminal searches for a vaccine installed in a memory of the portable terminal in step 303. The memory includes not only an internal memory of the portable terminal but also an external memory.

In step 305, the portable terminal determines whether the vaccine is damaged. Whether the vaccine is damaged may be determined using a program to monitor a vaccine of a storage area as described above.

If it is determined in step 305 that the vaccine installed in the memory is not damaged, the portable terminal performs a virus scan using an undamaged vaccine installed in the memory. Otherwise, if it is determined in step 305 that the vaccine installed in the memory is damaged, the portable terminal recovers the vaccine of the memory in step 307 using a backup area and then performs the virus scan.

In step 309, the portable terminal for performing the virus scan determines a version of the vaccine installed in the memory of the portable terminal before performing the virus scan process. In step 311, the portable terminal determines whether the vaccine installed in the memory is the latest (i.e., most recent) version.

If it is determined in step 311 that the vaccine installed in the memory is the latest version, the procedure of FIG. 3 ends. Otherwise, if it is determined in step 311 that the vaccine installed in the memory is not the latest version, the portable terminal connects to a vaccine server in step 313.

In step 315, the portable terminal requests the vaccine server to send a vaccine of the latest version. In step 317, the portable terminal receives the vaccine of the latest version from the vaccine server, so as to update the vaccine to the latest version. The vaccine server stores the vaccine of the latest version, and transmits the vaccine of the latest version to the portable terminal.

According to exemplary embodiments of the present invention, whether a vaccine is damaged is determined before performing a virus scan in order to avoid data damaged by a virus in a portable terminal, thereby solving a problem in which a virus scan process cannot be normally performed when the vaccine provided by the conventional portable terminal is damaged by the virus.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. An apparatus for performing a virus scan in a portable terminal, the apparatus comprising:
a memory divided into a storage area and a backup area to install a vaccine in the storage area and to back up the vaccine of the storage area in the backup area.

2. The apparatus of claim 1, further comprising:
a vaccine manager for determining whether the vaccine installed in the storage area is damaged by a virus when the portable terminal operates as a removable disk, and if it is determined that the vaccine installed in the storage area is damaged by the virus, for recovering the damaged vaccine to an undamaged vaccine based on a vaccine image of the backup area.

3. The apparatus of claim 2, wherein, if the vaccine is recovered to the undamaged vaccine and thereafter it is determined that the vaccine is not a most recent version, the vaccine manager requests a vaccine server to send a vaccine of the most recent version and stores the vaccine of the most recent version.

4. The apparatus of claim 2, wherein the vaccine manager scans the virus of the memory and performs an operation of the removable disk when the vaccine installed in the storage area is not damaged by the virus or after the damaged vaccine is recovered to the undamaged vaccine.

5. The apparatus of claim 2, wherein, if the portable terminal operates as the removable disk, an external memory is inserted into the portable terminal.

6. The apparatus of claim 1, wherein the storage area is an area in which user access is permitted, and the backup area is an area in which the user access is not permitted.

7. A method of performing a virus scan in a portable terminal, the method comprising:
dividing a memory into a storage area and a backup area;
installing a vaccine in the storage area; and
installing a backup of the vaccine in the backup area.

8. The method of claim 7, further comprising:
determining whether the vaccine installed in the storage area is damaged by a virus when the portable terminal operates as a removable disk; and
if it is determined that the vaccine installed in the storage area is damaged by the virus, recovering the damaged vaccine to an undamaged vaccine based on a vaccine image of the backup area.

9. The method of claim 8, further comprising:
after recovering to the damaged vaccine, determining a version of the recovered vaccine;
if the recovered vaccine is not most recent version, requesting a vaccine server to send a vaccine of the most recent version; and
storing the vaccine of the most recent version received from the vaccine server.

10. The method of claim 8, further comprising:
scanning the virus of the memory; and
performing an operation of the removable disk when the vaccine installed in the storage area is not damaged by the virus or after the damaged vaccine is recovered.

11. The method of claim 8, wherein, if the portable terminal operates as the removable disk, an external memory is inserted into the portable terminal.

12. The method of claim 7, wherein the storage area is an area in which user access is permitted, and the backup area is an area in which the user access is not permitted.

13. A portable terminal for performing a virus scan, the portable terminal comprising:
a memory divided into a storage area and a backup area to install a vaccine in the storage area and to back up the vaccine in the backup area; and
a vaccine manager for recovering the vaccine in the storage area to an uninfected vaccine when the vaccine is infected.

14. The portable terminal of claim 13, wherein the vaccine manager includes a monitoring unit for monitoring whether the vaccine of the storage area is infected by a virus.

15. The portable terminal of claim 13, wherein the vaccine manager determines a version of the vaccine before performing a virus scan based on the vaccine and updates the vaccine to the latest version.

16. The portable terminal of claim 14, wherein, when an external memory is inserted into the portable terminal or when the portable terminal operates as a removable disk, the monitoring unit monitors whether the vaccine of the storage area is infected by the virus.

17. A portable terminal, comprising:
a memory having a storage area in which user access is permitted and a backup area in which user access is not permitted, the storage area and the backup area each having a vaccine to scan for viruses in the portable terminal; and
a controller for scanning for viruses, for removing viruses via the vaccine, and, when the controller determines that the vaccine stored in the storage area is unusable, for replacing the vaccine stored in the storage area with the vaccine stored in the backup area.

18. The portable terminal of claim 17, further comprising:
a monitoring unit for monitoring the vaccine stored in the storage area,
wherein the controller determines whether the vaccine stored in the storage area is unusable based on a result of the monitoring by the monitoring unit.

19. The portable terminal of claim 17, wherein the controller determines that the vaccine stored in the storage area is unusable when the vaccine stored in the storage area is infected or when the vaccine stored in the storage area is found not to be present.

20. The portable terminal of claim 17, wherein the memory comprises a removable storage unit.
